(19) United States
(12) Patent Application Publication
(10) Pub. No.: US 2018/0025113 A1
(43) Pub. Date: Jan. 25, 2018

(54) EVENT DETAIL PROCESSING AT RUN-TIME

(71) Applicant: salesforce.com, Inc., San Francisco, CA (US)

(72) Inventors: Adam Torman, Walnut Creek, CA (US); Abhishek Bangalore Sreenivasa, Hayward, CA (US); Aakash Pradeep, Fremont, CA (US); Ivan Daya Weiss, Berkeley, CA (US); Soumen Bandyopadhyay, Glen Park, CA (US); Alex Warshavsky, Walnut Creek, CA (US); Samarpan Jain, Fremont, CA (US)

(21) Appl. No.: 15/218,468

(22) Filed: Jul. 25, 2016

(51) Int. Cl. G06F 19/00; G06F 17/30

(52) U.S. Cl. CPC G06F 19/322; G06F 17/30292; G06F 17/30598; G06F 17/30477; G06F 17/30345

(57) ABSTRACT

Disclosed are some examples of database systems, methods, and computer program products for run-time schema for event records. In some implementations, event records satisfying a query can be identified. Attribute-value pairs of data of those identified event records can be stored in an unstructured data field of an event record.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This patent document generally relates to event records in a computing environment and, more specifically, to techniques for run-time schema for event records.

### BACKGROUND

“Cloud computing” services provide shared resources, software, and information to computers and other devices upon request. In cloud computing environments, software can be accessible over the Internet rather than installed locally on in-house computer systems. Cloud computing typically involves over-the-Internet provision of dynamically scalable and often virtualized resources. Technological details can be abstracted from the users, who no longer have need for expertise in, or control over, the technology infrastructure “in the cloud” that supports them.

### BRIEF DESCRIPTION OF THE DRAWINGS

The included drawings are for illustrative purposes and serve only to provide examples of possible structures and operations for the disclosed inventive database systems, methods, systems, and computer program products for processing event detail at run-time. These drawings in no way limit any changes in form and detail that may be made by one skilled in the art without departing from the spirit and scope of the disclosed implementations.

FIG. 1 shows a system diagram of an example of architectural components 100 for run-time schema for event records according to some implementations.

FIG. 2 shows an example of a structured/unstructured data field.

FIG. 3 shows a flowchart of an example of a method 300 for run-time schema for event records according to some implementations.

FIG. 4A shows a block diagram of an example of an environment 10 in which an on-demand database service can be used in accordance with some implementations.

FIG. 4B shows a block diagram of an example of some implementations of elements of FIG. 4A and various possible interconnections between these elements.

FIG. 5A shows a system diagram of an example of architectural components of an on-demand database service environment 800, in accordance with some implementations.

FIG. 5B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations described or referenced herein are directed to different systems, methods, apparatus, and computer program products for run-time schema for event records. In some but not all implementations, a database system is used to store records, and the database system can be in the form of a multi-tenant database system. The records include data fields for storing corresponding values. For example, if the records are health-related records of patients visiting a doctor, then the data fields can include patient name, date of visit (for a doctor's appointment), and social security number as values for the data fields. Each visit from the patients can result in a separate record being generated and stored in one or more databases of the database system.

The data fields represent a database schema indicating the organization of data for the records. For example, the database schema for the health-related records includes the data fields to store values for patient name, date of visit, and social security number, as previously discussed. If a new data field should be added, then the database schema should be updated. For example, if a reason for the patient's visit is to be added as a new data field, then the database schema can be updated to include the new data field for the reason for the patient's visit.

In some implementations, the data fields are strongly-typed data fields. Strongly-typed data fields use a specific type of data format or structure. For example, for the patient name data field, it can be a strongly-typed data field using a string data type (e.g., a sequence of characters or letters). Accordingly, each value for that data field would be a string data type.

Often, the database schema is updated by a system administrator at the back-end (e.g., database administrator). However, a web developer at the front-end might want to modify the database schema so that the records store data for the new data field. As a result, a disconnect may exist between the system administrator at the back-end and the web developer at the front-end. For example, the web developer might want a different database schema than what the database administrator has currently established.

In some instances, the database schema can be updated to include a data field for storing values conforming to a JavaScript Object Notation (JSON) data type. The data field can be an “unstructured” data field, for example, used to store values of any or multiple data types, and therefore, is not a strongly typed data field. The JSON data type can be used to store attribute-value pairs of data. For example, the data field can store a JSON data value of doctor name (indicating an attribute) and John Doe (indicating the value for the attribute) as “DoctorName”:“John Doe.” Many different attribute-value pairs can be stored in the same data field conforming to the JSON data type. For example, one attribute-value pair can provide the doctor name and its corresponding value (e.g., as a string), a second attribute-value pair can provide the hospital name and its corresponding value (e.g., as a string providing the name of the hospital), a third attribute-value pair can provide the cost of a procedure and its corresponding value (e.g., in United States dollars or an integer data type or format), etc. Accordingly, the unstructured data field can store attribute-value pairs having values of different data types.

By including the JSON data field, the web administrator may be able to update the types of data to be stored in it such that new values are stored in the records at run-time. For example, if the database schema has data fields for patient name, date of visit, social security number, and the unstructured data field (e.g., the JSON data field), then the unstructured data field can be used to store additional data without generating a new data field. For example, if hospital name should be added, then the corresponding attribute-value pair (e.g., “Hospital”:“San Francisco General”) can be stored in the unstructured data field conforming to the JSON data type. If the web administrator wants to add new attribute-value pairs, then the web administrator can have the new attribute-value pairs assigned to be stored in the unstructured data field. As a result, the web administrator can adjust the types of data to be stored in the unstructured data field without changing the existing database schema. That is, the data can be stored in records of the database without adding a new data field itself.

In some implementations, the database of records (e.g., the health records) can be searched with a database query. Records identified as satisfying the query's parameters or requirements can then be displayed to a user. However, for health records, some compliance standards, such as some Health Insurance Portability and Accounting Act (HIPAA) standards, might require an audit to be able to identify who saw a patient's record, or even whether a record was listed among search results of patient records. As disclosed herein, with an unstructured data field, the results of the query can be stored therein using attribute-value pairs and queried itself later to perform an audit.

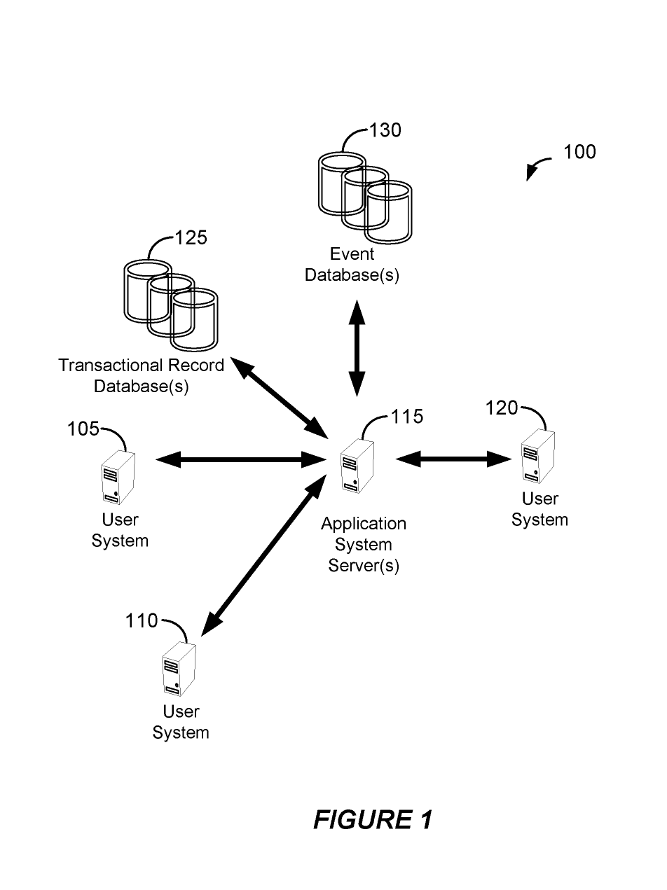

FIG. 1 shows a system diagram of an example of architectural components 100 for run-time schema for event records according to some implementations. Architectural components 100 may provide communications to be transmitted among a variety of different hardware and/or software components. In FIG. 1, architectural components 100 include application system server 115, user systems 105, 110, and 120, transactional record database 125, and event database 130. In some implementations, the functionality in architectural components 100 may be implemented in more or less servers or systems.

User systems 105, 110, and 120 may be any type of computing device. For example, user systems 105, 110, and 120 may be portable electronic devices such as smartphones, tablets, laptops, wearable devices (e.g., smart watches), etc. User systems 105, 110, and 120 may be another server or a desktop computer. Additionally, user systems 105, 110, and 120 may be different types of computing devices. For example, user system 105 may be a desktop computer whereas user system 110 may be a smartphone.

In some implementations, application system server 115 may include applications used by user systems 105, 110, and 120 to access records stored in transactional record database 125. As the user systems interact with the applications, records providing details on those interactions can be stored in event database 130. For example, if user system 105a uses application system server 115 to provide a query to search transactional record database 125, then a record can be generated in event database 130. Later, the records in event database 130 can be queried to search for details on those interactions. For example, user systems 105 and 110 might interact with applications provided by application system server 115 and access records stored in transactional record database 125, which results in corresponding records being generated and stored in event database 130. That is, each interaction can lead to an event allowing for event data to be stored in event database 130. If user system 120 is a web administrator, then it can then perform an audit on the interactions of user systems 105 and 110 by querying the records (e.g., event records) stored in event database 130.

Additionally, user system 120 can update the data fields of records from transactional record database 125 to be stored in the event records of event database 130 by using an unstructured data field. For example, using the example previously described, transactional record database 125 might store health records of patients visiting a doctor, for example, under HIPAA. If user system 105 queries transactional record database 125 and is provided search results of records satisfying the query, then those results might be saved in a record in event database 130 so that user system 120 can later perform an audit to determine which records were shown to user system 105. For example, the event records stored in event database 130 can include an unstructured data field that can be used to store the results of the query.

For example, the record in event database 130 can include strongly-typed data fields using a specific type of data format or structure. For example, one strongly-typed data field might be of a type string, and therefore, only textual characters might be allowed to be stored in the data field. Another strongly-typed data field can be of a type integer, and therefore, only numbers might be allowed to be stored in that data field.

Additionally, the records in the event database 130 can be configured to have a data field that is unstructured to store values of many different data formats. For example, the data field can conform to a JavaScript Object Notation (JSON) data type, which allows for attribute-value pairs of data. The attribute can indicate what the value represents. For example, “Doctor Name”:“John Doe” can be an attribute-value pair in which the attribute is identified as “Doctor Name” and it is associated with a value of “John Doe” which is a string for the name of a doctor. Another attribute-value pair might be “USD”:“$40” which is a United States dollar currency indicating $40. As a result, the unstructured data field can be a JSON data type that can store multiple attribute-value pairs that can have different data types.

The strongly-typed data fields can be used to store some of the query results. For example, one data field can be used to store the username of the user who queried transactional record database 125. Another data field can be used to store the query itself. An additional data field can be the unstructured data field having a JSON data type that can be used to store all of the search results of the query. That is, the unstructured data field can store data values of the data fields of the records shown as the result of a query.

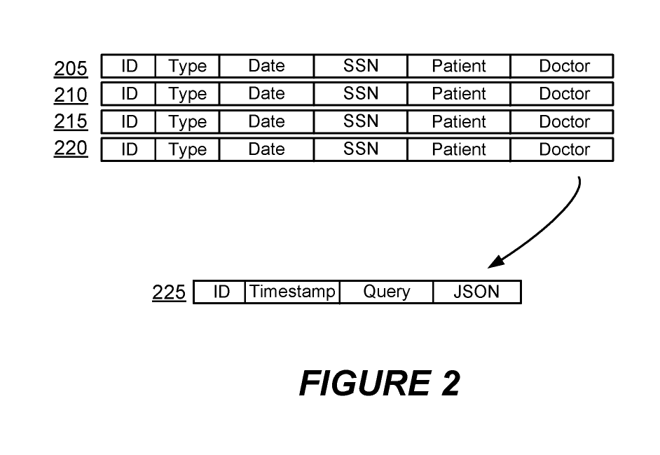

FIG. 2 shows an example of a structure/unstructured data field. In FIG. 2, event record 225 can be used to store results of querying transactional record database 125 in the JSON data field, which can be an unstructured data field, as previously discussed. For example, records 205-220 may be health records of patients stored in transactional record database 125. User system 105 might use application server system 115 to provide a query to search transactional record database 125. For example, the query might indicate that user system 105 wants to view records in transactional record database 125 in which a patient visited a specific doctor. As a result, records 205-220 might be identified as satisfying the query and some of the data of the data fields of those records can be displayed as the results of the query.

Records 205-220 include six data fields: id (e.g., a unique number representing an identifier for the record), type (e.g., representing the nature of the patient's visit to the doctor), date (e.g., representing the date of the patient's visit), SSN (e.g., the social security number of the patient), patient (e.g., representing the patient's name), and doctor (e.g., representing the doctor whom the patient visited). The values of some or all of the data fields of records 205-220 can be stored in the JSON data field of record 225 for storage in event database 130. For example, the values for the id, type, date, patient, and doctor data fields for records 205-220 can be stored as attribute-value pairs in the JSON data field of record 225. This results in the values for the SSN data fields not being stored in record 225.

Additionally, the query that was used can also be stored in the query data field, as well as the time of the query can stored in the timestamp data field for record 225. A unique identifier for the query can also be generated and stored in the id data field. Accordingly, record 225 can include a mix of strongly-typed and unstructured data fields. That is, the id, timestamp, and query data fields can be strongly-typed while the JSON data field can be unstructured with different attribute-value pairs, as previously discussed.

In some implementations, the values of data fields of records 205-220 to be stored in the JSON data field of record 225 can be updated. For example, a web administrator may use application system server 115 to start storing the values of the SSN data fields of records that satisfy the query in the JSON data field of record 225. Accordingly, if event database 130 has multiple records, the JSON data field for those records might include different attribute-value pairs, for example, one having an attribute-value pair for the SSN of records 205-220 while another record might not have the attribute-value pair for the SSN since the former might be from after the change to include the SSN. This may be possible because the JSON data field is an unstructured data field and can store any number of attribute-value pairs of any type. Additionally, since values of new data fields can be stored in the JSON data field, it is not necessary to change the schema of the records stored in event database 130. That is, a new data field does not need to be added. Rather, the new data can be added to the JSON data field by the web administrator without any action from the database administrator.

Moreover, by storing the query results in the JSON data field, a web administrator can perform an audit to determine whether someone accessed or saw a patient's record. For example, a query can be provided to application system server 115 and executed on the records in event database 130. Since the results of the query used to identify records in transactional records database 125 are stored in the JSON data field and that query stored in the query data field, it can be determined whether someone accessed a record or saw a record in a list of results.

For example, if the web administrator wishes to see who viewed a record of a particular patient or whether that particular patient's record was displayed in the search results for a query, then the JSON data fields of the records in event records 130 can be searched for the attribute-value pair. For example, if the JSON data fields store an attribute-value pair for the username of a user who performed a search and also store an attribute-value pair for the patient for whom the record is associated, then a query can be executed by application system sever 115 (e.g., provided by the web administrator) to search for those attribute-value pairs in event records 130. As a result, an audit can be performed by searching the JSON data fields of event records 130.

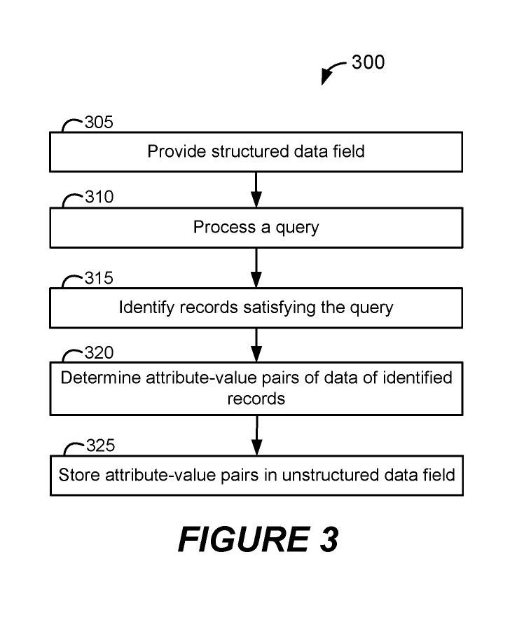

FIG. 3 shows a flowchart of an example of a method 300 for run-time schema for event records according to some implementations. In FIG. 3, at block 305, a structured data field can be provided. For example, a database administrator can update the database schema of event database 130 such that the records to be stored therein should include a JSON data field. At block 310, a query can be processed. For example, application system server 115 can receive a query to search and identify records of transactional record database 125 by parsing the query and determining the parameters to use to identify the records. At block 315, records satisfying the query can be identified. For example, records can be identified based on the parameters in the query and provided for display. At block 320, attribute-value pairs of data can be identified. For example, the attribute-value pairs of data to be stored in a JSON data field can be identified. At block 325, the attribute-value pairs can be stored in an unstructured data field. For example, the attribute-value pairs may be stored in a JSON data field of a record of event database 130.

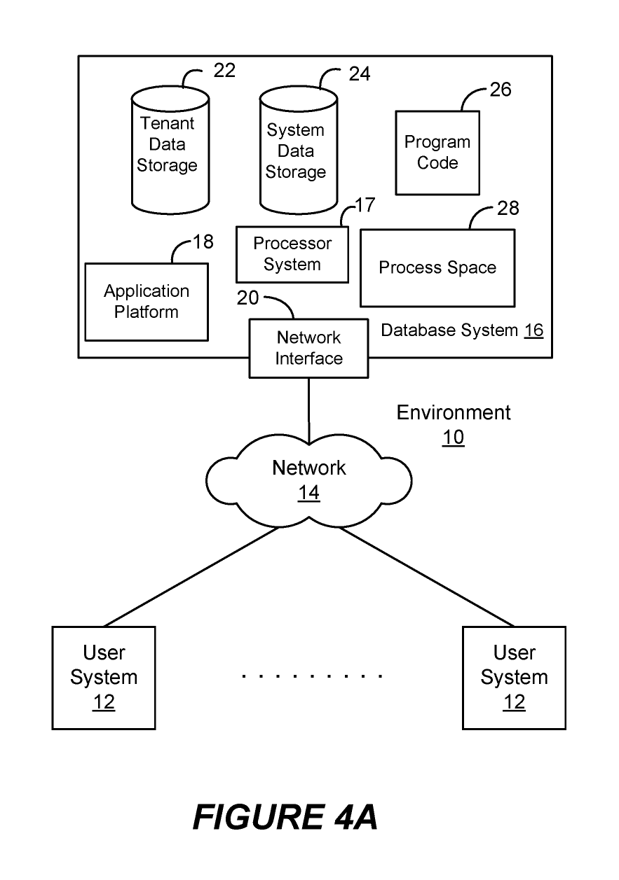

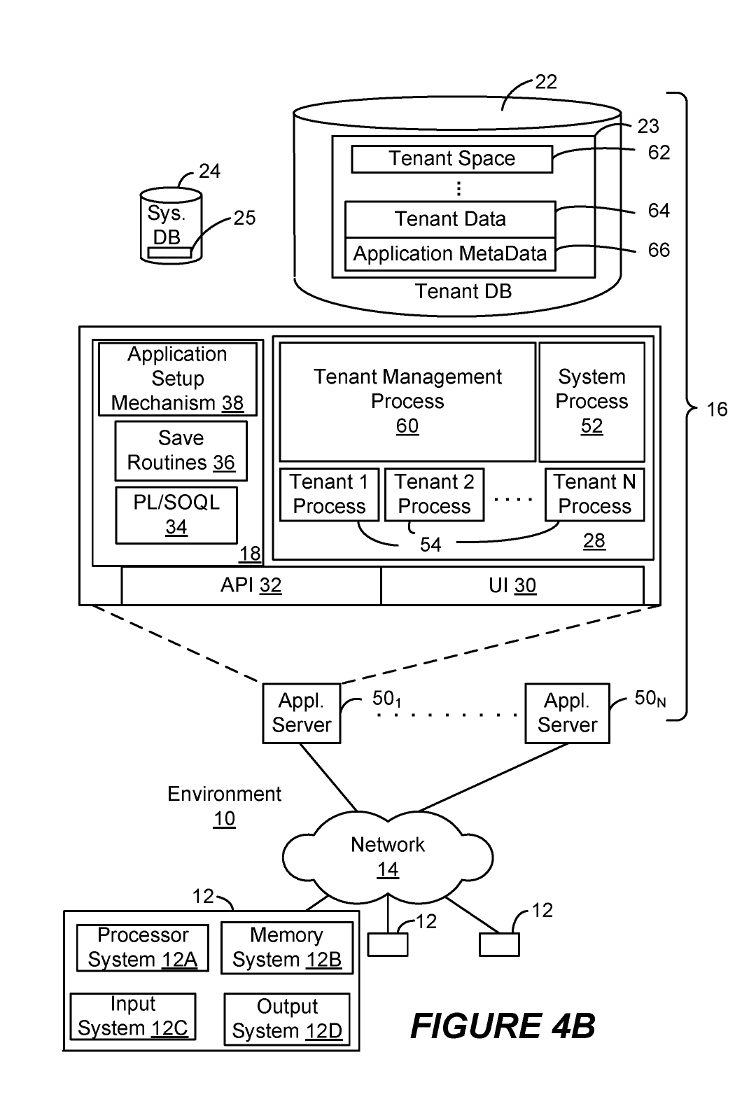

FIG. 4A shows a block diagram of an example of an environment 10 in which an on-demand database service can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

Environment 10 is an environment in which an on-demand database service exists. User system 12 may be implemented as any computing device(s) or other data processing apparatus such as a machine or system that is used by a user to access a database system 16. For example, any of user systems 12 can be a handheld computing device, a mobile phone, a laptop computer, a work station, and/or a network of such computing devices. As illustrated in FIG. 4A (and in more detail in FIG. 64) user systems 12 might interact via a network 14 with an on-demand database service, which is implemented in the example of FIG. 4A as database system 16.

An on-demand database service, implemented using system 16 by way of example, is a service that is made available to outside users, who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the “Internet” with a capital “I.” The Internet will be used in many of the examples herein. However, it should be understood that the networks that the present implementations might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 4A, implements a web-based customer relationship management (CRM) system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 6A and 6B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 4A include conventional, well-known elements that are explained only briefly here. For example, each user system 12 could include a desktop personal computer, workstation, laptop, PDA, tablet, smartphone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a graphical user interface (GUI) provided by the browser on a display (e.g., a monitor screen, LCD display, etc.) of the computing device in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to a computing device or system, including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 4B shows a block diagram of an example of some implementations of elements of FIG. 4A and various possible interconnections between these elements. That is, FIG. 4B also illustrates environment 10. However, in FIG. 4B elements of system 16 and various interconnections in some implementations are further illustrated. FIG. 4B shows that user system 12 may include processor system 12A, memory system 12B, input system 12C, and output system 12D. FIG. 4B shows network 14 and system 16. FIG. 4B also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 4A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 4B, system 16 may include a network interface 20 (of FIG. 4A) implemented as a set of HTTP application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

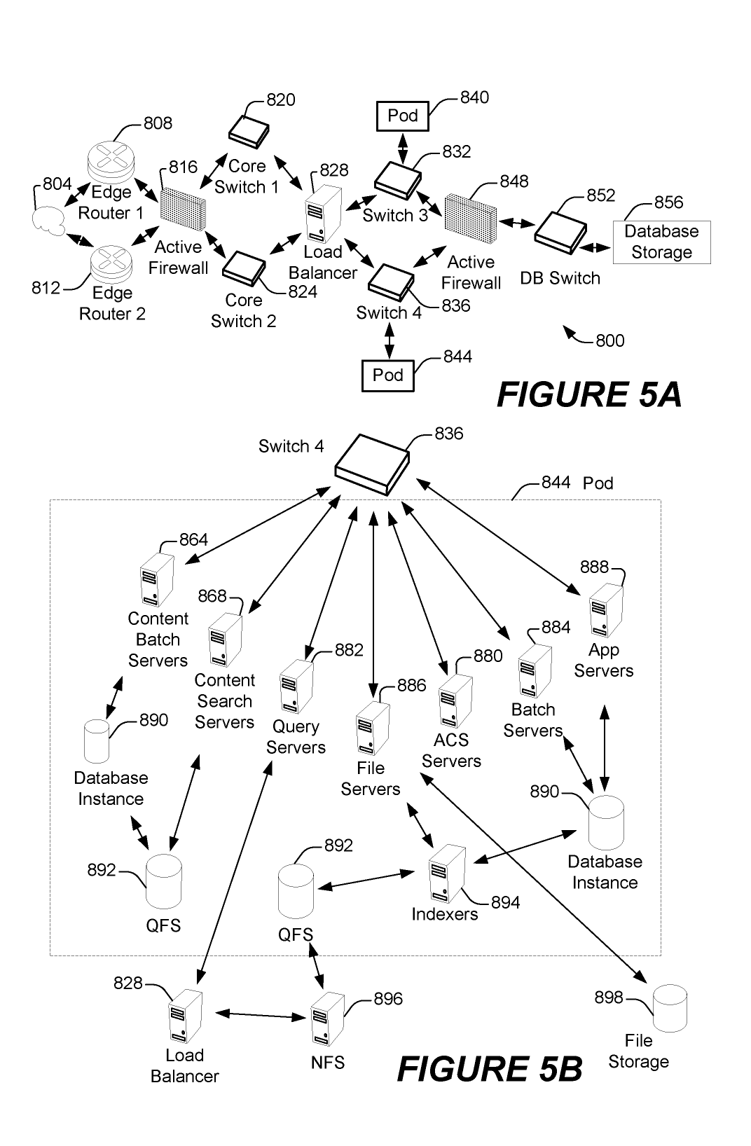

FIG. 5A shows a system diagram illustrating an example of architectural components of an on-demand database service environment 800 according to some implementations. A client machine located in the cloud 804, generally referring to one or more networks in combination, as described herein, may communicate with the on-demand database service environment via one or more edge routers 808 and 812. A client machine can be any of the examples of user systems 12 described above. The edge routers may communicate with one or more core switches 820 and 824 via firewall 816. The core switches may communicate with a load balancer 828, which may distribute server load over different pods, such as the pods 840 and 844. The pods 840 and 844, which may each include one or more servers and/or other computing resources, may perform data processing and other operations used to provide on-demand services. Communication with the pods may be conducted via pod switches 832 and 836. Components of the on-demand database service environment may communicate with a database storage 856 via a database firewall 848 and a database switch 852.

As shown in FIGS. 5A and 5B, accessing an on-demand database service environment may involve communications transmitted among a variety of different hardware and/or software components. Further, the on-demand database service environment 800 is a simplified representation of an actual on-demand database service environment. For example, while only one or two devices of each type are shown in FIGS. 5A and 5B, some implementations of an on-demand database service environment may include anywhere from one to many devices of each type. Also, the on-demand database service environment need not include each device shown in FIGS. 5A and 5B, or may include additional devices not shown in FIGS. 5A and 5B.

Moreover, one or more of the devices in the on-demand database service environment 800 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 804 is intended to refer to a data network or plurality of data networks, often including the Internet. Client machines located in the cloud 804 may communicate with the on-demand database service environment to access services provided by the on-demand database service environment. For example, client machines may access the on-demand database service environment to retrieve, store, edit, and/or process information.

In some implementations, the edge routers 808 and 812 route packets between the cloud 804 and other components of the on-demand database service environment 800. The edge routers 808 and 812 may employ the Border Gateway Protocol (BGP). The BGP is the core routing protocol of the Internet. The edge routers 808 and 812 may maintain a table of IP networks or ‘prefixes’, which designate network reachability among autonomous systems on the Internet.

In one or more implementations, the firewall 816 may protect the inner components of the on-demand database service environment 800 from Internet traffic. The firewall 816 may block, permit, or deny access to the inner components of the on-demand database service environment 800 based upon a set of rules and other criteria. The firewall 816 may act as one or more of a packet filter, an application gateway, a stateful filter, a proxy server, or any other type of firewall.

In some implementations, the core switches 820 and 824 are high-capacity switches that transfer packets within the on-demand database service environment 800. The core switches 820 and 824 may be configured as network bridges that quickly route data between different components within the on-demand database service environment. In some implementations, the use of two or more core switches 820 and 824 may provide redundancy and/or reduced latency.

In some implementations, the pods 840 and 844 may perform the core data processing and service functions provided by the on-demand database service environment. Each pod may include various types of hardware and/or software computing resources. An example of the pod architecture is discussed in greater detail with reference to FIG. 5B.

In some implementations, communication between the pods 840 and 844 may be conducted via the pod switches 832 and 836. The pod switches 832 and 836 may facilitate communication between the pods 840 and 844 and client machines located in the cloud 804, for example via core switches 820 and 824. Also, the pod switches 832 and 836 may facilitate communication between the pods 840 and 844 and the database storage 856.

In some implementations, the load balancer 828 may distribute workload between the pods 840 and 844. Balancing the on-demand service requests between the pods may assist in improving the use of resources, increasing throughput, reducing response times, and/or reducing overhead. The load balancer 828 may include multilayer switches to analyze and forward traffic.

In some implementations, access to the database storage 856 may be guarded by a database firewall 848. The database firewall 848 may act as a computer application firewall operating at the database application layer of a protocol stack. The database firewall 848 may protect the database storage 856 from application attacks such as structure query language (SQL) injection, database rootkits, and unauthorized information disclosure.

In some implementations, the database firewall 848 may include a host using one or more forms of reverse proxy services to proxy traffic before passing it to a gateway router. The database firewall 848 may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

In some implementations, communication with the database storage 856 may be conducted via the database switch 852. The multi-tenant database storage 856 may include more than one hardware and/or software components for handling database queries. Accordingly, the database switch 852 may direct database queries transmitted by other components of the on-demand database service environment (e.g., the pods 840 and 844) to the correct components within the database storage 856.

In some implementations, the database storage 856 is an on-demand database system shared by many different organizations. The on-demand database system may employ a multi-tenant approach, a virtualized approach, or any other type of database approach. An on-demand database system is discussed in greater detail with reference to FIGS. 7A and 7B.

FIG. 5B shows a system diagram further illustrating an example of architectural components of an on-demand database service environment according to some implementations. The pod 844 may be used to render services to a user of the on-demand database service environment 800. In some implementations, each pod may include a variety of servers and/or other systems. The pod 844 includes one or more content batch servers 864, content search servers 868, query servers 882, file servers 886, access control system (ACS) servers 880, batch servers 884, and app servers 888. Also, the pod 844 includes database instances 890, quick file systems (QFS) 892, and indexers 894. In one or more implementations, some or all communication between the servers in the pod 844 may be transmitted via the switch 836.

In some implementations, the app servers 888 may include a hardware and/or software framework dedicated to the execution of procedures (e.g., programs, routines, scripts) for supporting the construction of applications provided by the on-demand database service environment 800 via the pod 844. In some implementations, the hardware and/or software framework of an app server 888 is configured to execute operations of the services described herein, including performance of the blocks of methods described with reference to FIGS. 1-4. In alternative implementations, two or more app servers 888 may be included and cooperate to perform such methods, or one or more other servers described herein can be configured to perform the disclosed methods.

The content batch servers 864 may handle requests internal to the pod. These requests may be long-running and/or not tied to a particular customer. For example, the content batch servers 864 may handle requests related to log mining, cleanup work, and maintenance tasks.

The content search servers 868 may provide query and indexer functions. For example, the functions provided by the content search servers 868 may allow users to search through content stored in the on-demand database service environment.

The file servers 886 may manage requests for information stored in the File storage 898. The File storage 898 may store information such as documents, images, and basic large objects (BLOBs). By managing requests for information using the file servers 886, the image footprint on the database may be reduced.

The query servers 882 may be used to retrieve information from one or more file systems. For example, the query system 882 may receive requests for information from the app servers 888 and then transmit information queries to the NFS 896 located outside the pod.

The pod 844 may share a database instance 890 configured as a multi-tenant environment in which different organizations share access to the same database. Additionally, services rendered by the pod 844 may call upon various hardware and/or software resources. In some implementations, the ACS servers 880 may control access to data, hardware resources, or software resources.

In some implementations, the batch servers 884 may process batch jobs, which are used to run tasks at specified times. Thus, the batch servers 884 may transmit instructions to other servers, such as the app servers 888, to trigger the batch jobs.

In some implementations, the QFS 892 may be an open source file system available from Sun Microsystems® of Santa Clara, Calif. The QFS may serve as a rapid-access file system for storing and accessing information available within the pod 844. The QFS 892 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 868 and/or indexers 894 to identify, retrieve, move, and/or update data stored in the network file systems 896 and/or other storage systems.

In some implementations, one or more query servers 882 may communicate with the NFS 896 to retrieve and/or update information stored outside of the pod 844. The NFS 896 may allow servers located in the pod 844 to access information to access files over a network in a manner similar to how local storage is accessed.

In some implementations, queries from the query servers 822 may be transmitted to the NFS 896 via the load balancer 828, which may distribute resource requests over various resources available in the on-demand database service environment. The NFS 896 may also communicate with the QFS 892 to update the information stored on the NFS 896 and/or to provide information to the QFS 892 for use by servers located within the pod 844.

In some implementations, the pod may include one or more database instances 890. The database instance 890 may transmit information to the QFS 892. When information is transmitted to the QFS, it may be available for use by servers within the pod 844 without using an additional database call.

In some implementations, database information may be transmitted to the indexer 894. Indexer 894 may provide an index of information available in the database 890 and/or QFS 892. The index information may be provided to file servers 886 and/or the QFS 892.

As multiple users might be able to change the data of a record, it can be useful for certain users to be notified when a record is updated. Also, even if a user does not have authority to change a record, the user still might want to know when there is an update to the record. For example, a vendor may negotiate a new price with a salesperson of company X, where the salesperson is a user associated with tenant Y. As part of creating a new invoice or for accounting purposes, the salesperson can change the price saved in the database. It may be important for co-workers to know that the price has changed. The salesperson could send an email to certain people, but this is onerous and the salesperson might not email all of the people who need to know or want to know. Accordingly, some implementations of the disclosed techniques can inform others (e.g., co-workers) who want to know about an update to a record automatically.

The tracking and reporting of updates to a record stored in a database system can be facilitated with a multi-tenant database system 16, e.g., by one or more processors configured to receive or retrieve information, process the information, store results, and transmit the results. In other implementations, the tracking and reporting of updates to a record may be implemented at least partially with a single tenant database system.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects.

While the disclosed examples are often described herein with reference to an implementation in which an on-demand database service environment is implemented in a system having an application server providing a front end for an on-demand database service capable of supporting multiple tenants, the present implementations are not limited to multi-tenant databases nor deployment on application servers. Implementations may be practiced using other database architectures, i.e., ORACLE®, DB2® by IBM and the like without departing from the scope of the implementations claimed.

It should be understood that some of the disclosed implementations can be embodied in the form of control logic using hardware and/or using computer software in a modular or integrated manner. Other ways and/or methods are possible using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer-readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer-readable medium may be any combination of such storage or transmission devices. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system comprising:
at least one event database storing data objects corresponding to event records;
at least one server capable of executing instructions configurable to cause:
providing a structured data field for event records stored in the event database of the database system;
processing a query;
identifying one or more records stored in one or more databases of the database system as satisfying the query, the one or more databases being different from the event database;
determining attribute-value pairs of data corresponding to data fields and values of the data fields of the identified one or more records stored in the one or more databases; and
storing the determined attribute-value pairs of data in the unstructured data field of one or more of the event records stored in the event database.

2. The database system of claim 1, wherein the unstructured data field is in a JavaScript Object Notation (JSON) format.

3. The database system of claim 1, wherein the one or more records stored in the one or more databases are health-related records of patients.

4. The database system of claim 1, wherein the attribute-value pairs of data stored in the unstructured data field includes a first attribute-value pair having a first data type and a second attribute-value pair having a second data type, the first data type and the second data type being different.

5. The database system of claim 4, wherein the one or more of the event records stored in the event database include a strongly-typed data field, and wherein the database system stores the query used to identify the records in the strong-typed data field.

6. The database system of claim 4, wherein the one or more of the event records stored in the event database include a strongly-typed data field having the first data type.

7. The database system of claim 1, wherein a first event record of the one or more of the event records stored in the event database has a first grouping of attribute-value pairs in the corresponding unstructured data field, a second event record of the one or more of the event records stored in the event database has a second grouping of attribute-value pairs in the corresponding unstructured data field, the first grouping being different than the second grouping.

8. A method for storing unstructured data using a database system, the method comprising:
providing, using a database system, an unstructured data field for event records stored in a event database of the database system;
processing, using the database system, a query;
identifying, using the database system, one or more records stored in one or more databases of the database system as satisfying the query, the one or more databases being different from the event database;
determining, using the database system, attribute-value pairs of data corresponding to data fields and values of the data fields of the identified one or more records stored in the one or more databases; and
storing the determined attribute-value pairs of data in the unstructured data field of one or more of the event records stored in the event database.

9. The method of claim 8, wherein the unstructured data field is in a JavaScript Object Notation (JSON) format.

10. The method of claim 8, wherein the one or more records stored in the one or more databases are health-related records of patients.

11. The method of claim 8, wherein the attribute-value pairs of data stored in the unstructured data field includes a first attribute-value pair having a first data type and a second attribute-value pair having a second data type, the first data type and the second data type being different.

12. The method of claim 11, wherein the one or more of the event records stored in the event database include a strongly-typed data field, and wherein the database system stores the query used to identify the records in the strong-typed data field.

13. The method of claim 11, wherein the one or more of the event records stored in the event database include a strongly-typed data field having the first data type.

14. The method of claim 8, wherein a first event record of the one or more of the event records stored in the event database has a first grouping of attribute-value pairs in the corresponding unstructured data field, a second event record of the one or more of the event records stored in the event database has a second grouping of attribute-value pairs in the corresponding unstructured data field, the first grouping being different than the second grouping.

15. A computer program product comprising program code to be executed by at least one processor when retrieved from a non-transitory computer-readable medium, the program code comprising instructions configurable to cause:
providing an unstructured data field for event records stored in a event database of a database system;
processing a query;
identifying one or more records stored in one or more databases of the database system as satisfying the query, the one or more databases being different from the event database;
determining attribute-value pairs of data corresponding to data fields and values of the data fields of the identified one or more records stored in the one or more databases; and
storing the determined attribute-value pairs of data in the unstructured data field of one or more of the event records stored in the event database.

16. The computer program product of claim 15, wherein the unstructured data field is in a JavaScript Object Notation (JSON) format.

17. The computer program product of claim 15, wherein the one or more records stored in the one or more databases are health-related records of patients.

18. The computer program product of claim 15, wherein the attribute-value pairs of data stored in the unstructured data field includes a first attribute-value pair having a first data type and a second attribute-value pair having a second data type, the first data type and the second data type being different.

19. The computer program product of claim 18, wherein the one or more of the event records stored in the event database include a strongly-typed data field, and wherein the database system stores the query used to identify the records in the strong-typed data field.

20. The computer program product of claim 15, wherein the one or more of the event records stored in the event database include a strongly-typed data field having the first data type.
